(19) United States
(12) Patent Application Publication
(10) Pub. No.: US 2024/0294128 A1
(43) Pub. Date: Sep. 5, 2024

(54) OPEN/CLOSE CONTROL APPARATUS AND VEHICLE

(71) Applicant: ISUZU MOTORS LIMITED, Yokohama-shi (JP)

(72) Inventors: Shouhei NAKAYAMA, Fujisawa-shi (JP); Takuya KIKUCHI, Fujisawa-shi (JP); Ryuichi TAKAO, Fujisawa-shi (JP); Akihiro NAGAFUCHI, Fujisawa-shi (JP)

(21) Appl. No.: 18/583,754

(22) Filed: Feb. 21, 2024

(30) Foreign Application Priority Data
Mar. 2, 2023 (JP) 2023-031535

(51) Int. Cl. B60R 16/03

(52) U.S. Cl. CPC B60R 16/03

(57) ABSTRACT

An open/close control apparatus is an open/close control apparatus for a vehicle including a battery and an open/close section that opens and closes a power supply path from the battery to a load. The open/close control apparatus includes a measuring section that measures time elapsed since issuance of a power supply stop instruction for the load and a control section that keeps the open/close section closed when the elapsed time is shorter than a set period of time.

### TECHNICAL FIELD

The present discloses relates to an open/close control apparatus and a vehicle.

### BACKGROUND ART

It is known that batteries are provided for vehicles capable of operating on electric power. A battery supplies power to a load when a relay (open/close section) provided for a power supply path to the battery closes.

Such an open/close section opens when a power supply stop instruction for a load is issued, and closes when a power supply start instruction for the load is issued. PTL 1, for example, discloses a configuration where an open/close section switches from a closed state to an open state when a value of a current in a power line falls below a certain value after a power supply stop instruction is issued.

### CITATION LIST

### Patent Literature

PTL 1
Japanese Patent No. 6479247

### SUMMARY OF INVENTION

### Technical Problem

Vehicles might repeatedly run and stop at short time intervals. In this case, an open/close section repeatedly opens and closes at short time intervals. Life of an open/close section is determined on the basis of the total number of times of opening and closing and a value of a current applied when the open/close section closes, and the total number of times of opening and closing of the open/close section might prematurely reach an upper limit when the open/close section repeatedly opens and closes at short time intervals.

The present disclosure aims to provide an open/close control apparatus and a vehicle capable of inhibiting the total number of times of opening and closing of open/close sections from prematurely reaching an upper limit.

### Solution to Problem

An open/close control apparatus according to the present disclosure is an apparatus for a vehicle including a battery and an open/close section that opens and closes a power supply path from the battery to a load, the open/close control apparatus including: a measuring section that measures time elapsed since issuance of a power supply stop instruction for the load; and a control section that keeps the open/close section closed when the elapsed time is shorter than a set period of time.

A vehicle according to the present disclosure includes: a battery; an open/close section that opens and closes a power supply path from the battery to a load; a measuring section that measures time elapsed since issuance of a power supply stop instruction for the load; and a control section that keeps the open/close section closed when the elapsed time is shorter than a set period of time.

### Advantageous Effects of Invention

According to the present disclosure, the total number of times of opening and closing of open/close sections can be inhibited from prematurely reaching an upper limit.

### BRIEF DESCRIPTION OF DRAWINGS

FIG. 1 is a diagram illustrating a vehicle including an open/close control apparatus according to an embodiment of the present disclosure; and

FIG. 2 is a flowchart illustrating an example of operation for open/close control performed by the open/close control apparatus.

### DESCRIPTION OF EMBODIMENTS

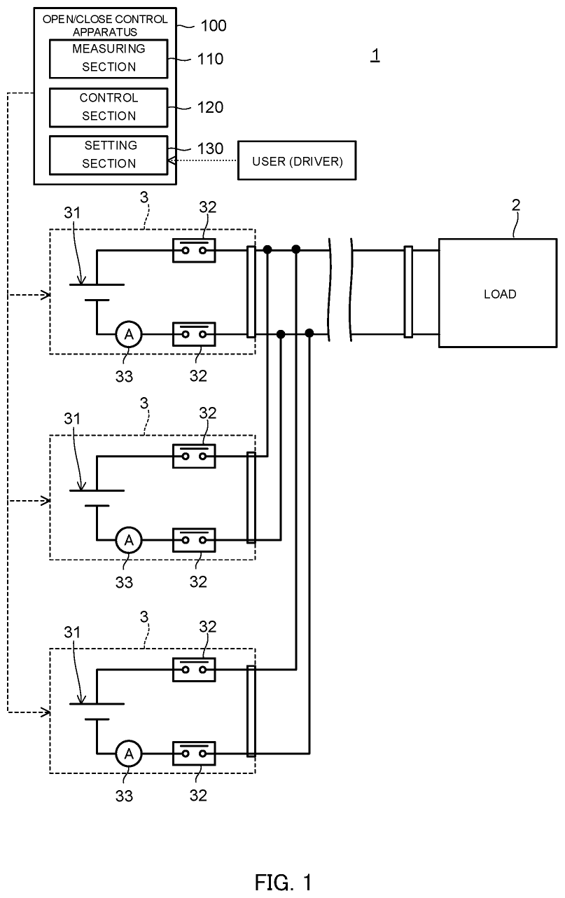

An embodiment of the present disclosure will be described in detail hereinafter. FIG. 1 is a diagram illustrating a vehicle provided with an open/close control apparatus according to the embodiment of the present disclosure.

As illustrated in FIG. 1, vehicle 1 is a vehicle capable of running using batteries 31, such as an electric car or a hybrid vehicle. Vehicle 1 includes, for example, load 2 capable of operating on electric power, such as a motor, battery apparatuses 3, and open/close control apparatus 100. Vehicle 1 performs, using open/close control apparatus 100, control for inhibiting the total number of times of opening and closing of open/close sections 32, which will be described later, from prematurely reaching an upper limit.

Battery apparatuses 3 are connected in parallel with one another and capable of supplying power to load 2. Each battery apparatus 3 has the same configuration, that is, includes battery 31 and open/close sections 32.

Battery 31 is capable of supplying power to load 2 because positive and negative terminals thereof are connected to power supply paths connected to load 2.

Open/close sections 32 are, for example, relays that open and close the power supply paths of battery 31, and one open/close section 32 is provided for each of positive and negative power supply paths of battery 31.

When open/close sections 32 close, power can be supplied to load 2 from battery 31 through the power supply paths. When open/close sections 32 open, the power supply paths are disconnected, and power is not supplied to load 2 from battery 31.

Open/close control apparatus 100 includes a central processing unit (CPU), a read-only memory (ROM), a random-access memory (RAM), and an input/output circuit, which are not illustrated. The CPU reads a program stored in the ROM and executes functions of measuring section 110, control section 120, and setting section 130. Open/close control apparatus 100 is capable of obtaining a key ON operation instruction (power supply start instruction) and a key OFF operation instruction (power supply stop instruction) issued by a driver of vehicle 1, for example, and controls open/close states of open/close sections 32 of each battery apparatus 3 on the basis of these instructions.

More specifically, when obtaining a power supply start instruction, open/close control apparatus 100 closes open/close sections 32, and when obtaining a power supply stop instruction, open/close control apparatus 100 opens open/close sections 32. Open/close control apparatus 100 includes measuring section 110, control section 120, and setting section 130.

Measuring section 110 measures, when a power supply stop instruction for load 2 is issued while batteries 31 are supplying power to load 2, time elapsed since the power supply stop instruction was issued. For example, measuring section 110 may be a timer apparatus.

Control section 120 obtains information regarding elapsed time measured by measuring section 110 and keeps open/close sections 32 closed until the elapsed time becomes longer than or equal to a set period of time. That is, while the elapsed time is shorter than the set period of time, control section 120 keeps open/close sections 32 closed.

Setting section 130 sets a period of time for which open/close sections 32 are to be kept closed. The set period of time may be a period of time from the driver stopping vehicle 1 until the driver begins to move vehicle 1 again and may be a period of time within which the driver can finish a couple of things to do. The set period of time is, for example, 10 minutes. The set period of time can be set by the driver (user). It is assumed that the driver sets the set period of time by operating an operation member of vehicle 1. The set period of time may be set by a manager of vehicle 1, instead. The set period of time may be a fixed value set in advance during manufacture of vehicle 1, instead.

The couple of things to do may include, for example, purchase of food and beverages to eat and drink in the vehicle, unloading of a package loaded on vehicle 1 from vehicle 1 and delivering the package to a delivery destination, reception of a package from a person at a position at which vehicle 1 has stopped and loading of the package onto vehicle 1, and/or loading of an object at a position at which vehicle 1 has stopped onto vehicle 1.

When the elapsed time becomes longer than or equal to the set period of time and a power supply start instruction has not been obtained, control section 120 opens open/close sections 32.

As a result, open/close sections 32 are kept closed until the set period of time has elapsed since the power supply stop instruction was issued. Consequently, even when the driver performs a key OFF operation for a couple of things to do and then performs a key ON operation relatively early, open/close sections 32 do not switch between an open state and a closed state. As a result, since the number of times of opening and closing of open/close sections 32 does not change, the total number of times of opening and closing of open/close sections 32 can be inhibited from reaching an upper limit.

When a power supply start instruction for load 2 is issued, control section 120 closes open/close sections 32. More specifically, when a power supply start instruction is issued when open/close sections 32 are open, control section 120 closes open/close sections 32. When a power supply start instruction is issued when open/close sections 32 are closed and the set period of time has not elapsed since a power supply stop instruction was issued, control section 120 keeps open/close sections 32 closed.

As a result, since open/close sections 32 switch only when necessary, open/close sections 32 can be inhibited from opening and closing in vain.

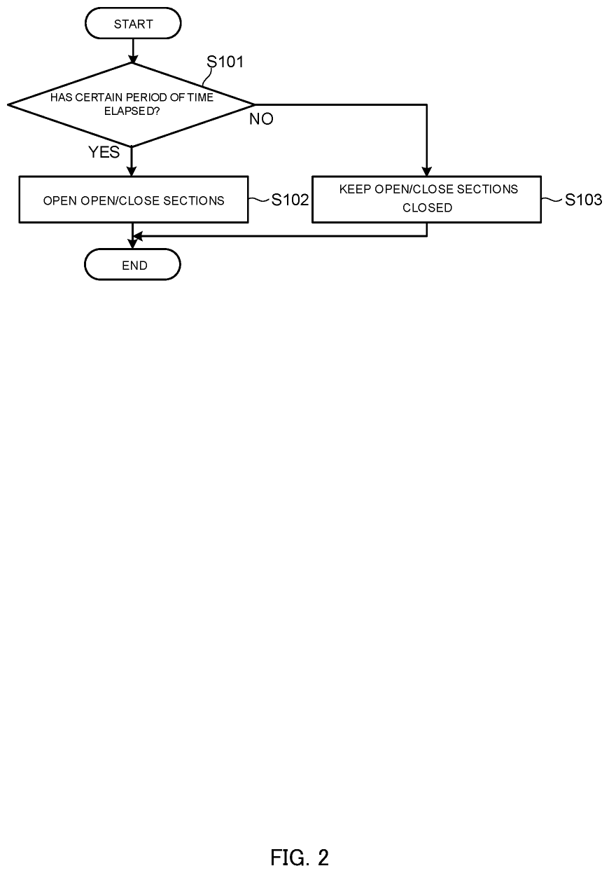

An example of operation for open/close control performed by open/close control apparatus 100 configured as described above will be described. FIG. 2 is a flowchart illustrating an example of the operation for the open/close control performed by open/close control apparatus 100. A process illustrated in FIG. 2 is performed as appropriate when, for example, a power supply stop instruction is issued when open/close sections 32 are open.

As illustrated in FIG. 2, open/close control apparatus 100 determines whether the set period of time has elapsed (step S101). When determining that the set period of time has elapsed (YES in step S101), open/close control apparatus 100 opens open/close sections 32 (step S102).

When the set period of time has not elapsed (NO in step S101), on the other hand, open/close control apparatus 100 keeps open/close sections 32 closed (step S103).

After step S102 or step S103, the control ends. After the processing in step S103, the processing in step S101 may be performed again. When a power supply start instruction is issued after step S102 or step S103, open/close control apparatus 100 may close open/close sections 32.

According to the present embodiment configured as above, open/close sections 32 do not switch between the open state and the close state until the set period of time has elapsed since a power supply stop instruction was issued.

When vehicle 1 is used for delivery of packages or the like, for example, the driver might repeat a sequence of actions where the driver, after stopping vehicle 1, delivers a package to a delivery destination and immediately returns to vehicle 1 to start driving vehicle 1. Since such a sequence of actions is performed in a short period of time, the total number of times of opening and closing of open/close sections 32 tends to reach an upper limit when open/close sections 32 switch for each sequence of actions.

In the present embodiment, even when the driver performs a key OFF operation for a couple of things to do and then performs a key ON operation relatively early, open/close sections 32 do not switch between the open state and the closed state. As a result, since the number of times of opening and closing of open/close sections 32 does not change, the total number of times of opening and closing of open/close sections 32 can be inhibited from reaching an upper limit.

In addition, when a power supply start instruction for load 2 is issued, open/close sections 32 are closed. That is, open/close sections 32 switch only when necessary. As a result, open/close sections 32 can be inhibited from opening and closing in vain.

In addition, measuring section 110 may reset the elapsed time when a power supply start instruction is issued.

Although control section 120 opens open/close sections 32 when the elapsed time becomes longer than or equal to the set period of time and a power supply start instruction has not been obtained in the above embodiment, the present disclosure is not limit to this. For example, control section 120 may open open/close sections 32 when the elapsed time becomes longer than or equal to the set period of time, regardless of a value of a current flowing through the power supply paths.

Although setting section 130 is provided in the above embodiment, the present disclosure is not limited. For example, when the set period of time is a preset value, setting section 130 need not be provided.

Although three battery apparatuses 3 are provided for vehicle 1 in the above embodiment, the present disclosure is not limited to this. One or two battery apparatuses may be provided for vehicle 1, or four or more battery apparatuses may be provided for vehicle 1, instead.

Although open/close control apparatus 100 is provided for vehicle 1 in the above embodiment, the present disclosure is not limited to this. Open/close control apparatus 100 may be provided for an apparatus other than vehicle 1 (e.g., a mobile terminal or a server), instead.

Furthermore, the above embodiment is just a specific example where the present disclosure is implemented, and should not be construed as limiting the technical scope of the present disclosure. That is, the present disclosure can be implemented in various manners without deviating from the spirit or principal features thereof.

This application is entitled and claims the benefit of Japanese Patent Application No. 2023-031535, filed on Mar. 2, 2023, the disclosure of which including the specification, drawings and abstract is incorporated herein by reference in its entirety.

### INDUSTRIAL APPLICABILITY

The open/close control apparatus in the present disclosure is effective as an open/close control apparatus and a vehicle capable of inhibiting the total number of times of opening and closing of open/close sections from prematurely reaching an upper limit.

1. An open/close control apparatus for a vehicle including a battery and an open/close section that opens and closes a power supply path from the battery to a load, the open/close control apparatus comprising:
a measuring section that measures time elapsed since issuance of a power supply stop instruction for the load; and
a control section that keeps the open/close section closed when the elapsed time is shorter than a set period of time.

2. The open/close control apparatus according to claim 1,
wherein, when the elapsed time is longer than or equal to the set period of time, the control section opens the open/close section.

3. The open/close control apparatus according to claim 2,
wherein, when the elapsed time is longer than or equal to the set period of time, the control section opens the open/close section regardless of a value of a current flowing through the power supply path.

4. The open/close control apparatus according to claim 1,
wherein, when a power supply start instruction for the load is issued, the control section closes the open/close section.

5. The open/close control apparatus according to claim 1, further comprising:
a setting section with which a user of the vehicle sets the set period of time.

6. A vehicle comprising:
a battery;
an open/close section that opens and closes a power supply path from the battery to a load;
a measuring section that measures time elapsed since issuance of a power supply stop instruction for the load; and
a control section that keeps the open/close section closed when the elapsed time is shorter than a set period of time.
